(19) United States
(12) Patent Application Publication
(10) Pub. No.: US 2026/0013497 A1
(43) Pub. Date: Jan. 15, 2026

(54) Aqueous tannin nanoparticle dispersions, their preparation and uses thereof

(71) Applicant: Teknologian tutkimuskeskus VTT Oy, Espoo (FI)

(72) Inventor: Petri Widsten, Espoo (FI)

(21) Appl. No.: 19/115,831

(22) PCT Filed: Sep. 22, 2023
(86) PCT No.: PCT/FI2023/050542

§ 371 Date: Mar. 27, 2025

(30) Foreign Application Priority Data
Sep. 27, 2022 (FI) 20225836

(51) Int. Cl. A01N 25/24; A01N 25/12; A01N 65/00; A01P 1/00; C09D 5/14; C09D 5/18; C09D 7/40; C09D 7/63

(52) U.S. Cl. CPC A01N 25/24; A01N 25/12; A01N 65/00; A01P 1/00; C09D 5/14; C09D 5/18; C09D 7/63; C09D 7/67

(57) ABSTRACT

The present invention relates to novel aqueous tannin nanoparticle dispersions, to a method for their preparation and to the use of the aqueous tannin nanoparticle dispersions, particularly in tannin nanoparticle coatings. Tannin nanoparticles (TNPs) are prepared by dissolution of water-insoluble tannins in an organic solvent or a mixture of organic solvent and water, followed by nanoprecipitation or solvent-exchange to obtain the tannin nanoparticle dispersions.

### FIELD

The present invention relates to novel aqueous tannin nanoparticle (TNP) dispersions, to a method for their preparation and to the use of the aqueous tannin nanoparticle dispersions, particularly in tannin nanoparticle coatings. Tannin nanoparticles are prepared by dissolution of water-insoluble tannins in an organic solvent or a mixture of organic solvent and water, followed by nanoprecipitation or solvent-exchange to obtain the tannin nanoparticle dispersions.

### BACKGROUND

Tannins are polyphenolic compounds found in various plant sources, including for example wood, bark, rhizomes, roots and fruits. Among coniferous trees spruce and pine, in particular spruce bark and pine bark, are typical sources of tannins. Spruce bark contains approximately 10.7% tannin while the tannin content of pine bark is about 6.3% (Kemppainen et al, 2014). Bark is obtained in considerable amounts as a residue of roundwood production. Currently this by-product is used for rather low-value applications, such as mulching and soil improvement, or as a fuel.

Most of the tannins from conifer bark are water-insoluble at room temperature at acidic pH levels. Commercial condensed and hydrolysable tannins such as those obtained from mimosa, quebracho, chestnut, oak, valonea, tara and other wood species as well as commercial tannic acid (a purified gallotannin) are soluble in water at room temperature and at acidic or neutral pH.

Tannins from conifer bark that are insoluble in water at room temperature may be produced by alkali-extraction, hot-water extraction, or mild alkali extraction. Lignin (typically 0-30% of the yield of tannin) may be co-extracted with tannin, depending on the extraction process.

Lignin nanoparticles (LNPs) have previously been prepared from water-insoluble technical lignins by dissolving lignin, e.g., in aqueous acetone and then evaporating off the acetone (Widsten et al, 2020). Some attempts to prepare tannin-based nanoparticles from water-soluble tannins have been made. However, said nanoparticles are typically hybrid nanoparticles of water-soluble tannin and other materials, such as PVA, metals or Carbopol gel (Aguilera et al, 2016; Limaye et al, 2019; AlMalki et al, 2021). Coatings made with water-soluble tannins disintegrate easily when in contact with water. On the other hand, large, micro-sized tannin particles of water-insoluble tannins do not form stable aqueous dispersions required for coating application by commonly used methods such as spraying and dipping and when applied by other methods, may result in poor coating properties. Solis-Pomar et al (2021) studied intumescent and fire-retardant properties of high-molecular weight tannins having a particle size of 4 Hegman (50 μm) in coating applications.

CN 113059656 relates to hybrid lignin-tannin micro-nanoparticles, which are prepared by mixing lignin and tannin and converting them to micro-and nano-sized particles having a mean particle size from 300 to 1100 nm. DE 202015100862 relates to hybrid nanoparticles comprising tannin, sodium pyrithione and silica. CN 112472693 relates to a vegetable tannin antibacterial agent prepared by, e.g., dissolving vegetable tannin, nucleophilic reagents and antioxidants in polar solvents, mixing with mineral acid, and reacting with aldehydes.

Therefore, there still exists need to obtain TNPs comprising or consisting essentially of tannin. There exists also a need to find value-added use to a largely undervalued by-product with a large production volume, namely conifer bark from roundwood production. Moreover, stable tannin dispersions in water could be valuable for coating applications, e.g., by spraying or dipping.

### SUMMARY OF THE INVENTION

The invention is defined by the features of the independent claims. Some specific embodiments are defined in the dependent claims.

The present invention is based on the concept of preparing novel TNP dispersions from tannins, which are insoluble in water at room temperature, by a nanoprecipitation method, also known as solvent-exchange method. The novel TNP dispersions may be used as such or after modification as coatings or surface treatment agents to impart the coated substrates or surfaces with antimicrobial, flame retardant, barrier or other functional properties.

According to a first aspect of the present invention, there is thus provided a method of preparing aqueous TNP dispersions, wherein the method comprises the steps of providing tannins that are insoluble in water under ambient conditions without pH adjustment, dissolving the water-insoluble tannins in an organic solvent or in a mixture of an organic solvent and water to obtain a solution of dissolved tannins, adding the tannin solution into an excess of water whereby a mostly aqueous dispersion of TNPs is formed, optionally removing the residual organic solvent, recovering the aqueous TNP dispersion, and optionally concentrating or drying the dispersion, wherein the tannin nanoparticles have an intensity-based particle size of ≤200 nm, measured by DLS (Dynamic Light Scattering).

According to a second aspect of the present invention, there is provided an aqueous TNP dispersion, wherein the nanoparticles comprise 60-90% TNPs by weight, preferably at least 70%, more preferably at least 80%, or wherein the nanoparticles consist essentially of TNPs, depending on the exact composition of the tannin-rich starting material, and wherein the TNPs have an intensity-based average particle size of ≤200 nm, measured by DLS (Dynamic Light Scattering).

A further aspect of the invention relates to the use of the aqueous TNP dispersions as coatings or surface treatment agents, preferably to impart antimicrobial, flame retardant, barrier or other functional properties or combinations thereof to coated surfaces or substrates.

Embodiments of the invention comprise a method for treating substrates for imparting them with antimicrobial, flame retardant or other functional properties, comprising coating said substrates with the aqueous TNP dispersions of the invention, optionally by depositing alternating layers of the aqueous TNP dispersion and of at least one adhesion and cohesion promoter, preferably a protein, on said substrates as an interlayer between two layers of TNPs or as a top layer.

Considerable advantages are obtained by the invention. First, to the inventor's knowledge, before the present invention the preparation of TNPs from tannins, which are water-insoluble at room temperature without pH adjustment, has not been possible, by nanoprecipitation or by any other methods.

Second, the aqueous TNP dispersions formed by the present method are suitable for coating and other surface treatment applications. Commercial condensed and hydrolysable tannins as well as commercial tannic acid are soluble in water at acidic or neutral pH at room temperature. Therefore, they cannot be used to make aqueous TNP dispersions for the above-mentioned applications.

Third, the aqueous TNP dispersions obtained by the present method have been observed to remain stable for several months.

Further, the present method of treating substrates for imparting them with antimicrobial, flame retardant or other functional properties may provide coatings that are mechanically very strong and completely or nearly completely water-resistant. In addition, the coatings based on aqueous TNP dispersions may be mostly or even 100% bio-based, since the main or only solid ingredient in the TNP dispersions is the mostly tannin-containing extract from (softwood) bark and the preferred optional adhesion promoters (proteins) are also bio-based. This is an advantage, compared to present antimicrobial coatings which are mainly based on silver or other antimicrobial metals in nanoparticle or cationic form, quaternary ammonium salts and other antimicrobial agents, as well as compared to present halogenated and other harmful synthetic flame retardants.

Further features and advantages of the present technology will appear from the following description of some embodiments.

### BRIEF DESCRIPTION OF THE DRAWINGS

FIG. 1 shows particle size distribution of spruce TNPs (mean size 83 nm).

FIG. 2 is a SEM image of freeze-dried spruce tannin TNPs.

FIG. 3 illustrates minimum inhibitory concentration (MIC) of TNPs vs lignin nanoparticles (LNPs) against methicillin-resistant Staphylococcus aureus (MRSA) and Escherichia coli (E. coli).

FIG. 4 illustrates antimicrobial efficacy of TNP coatings vs LNP coatings against MRSA.

FIG. 5 illustrates the effect of N-tannin as a flame-retardant component in micro-scale combustion calorimetry (MCC) testing. The figures show PHRR (peak heat release rate) and THR (total heat release) values and char yield for bleached kraft pulp, tannin and N-modified tannin (FIG. 5A) and for a combination of pulp and N-modified tannin (FIG. 5B). For context, lower PHRR and THR values and a higher char yield are desirable properties for flame retardants.

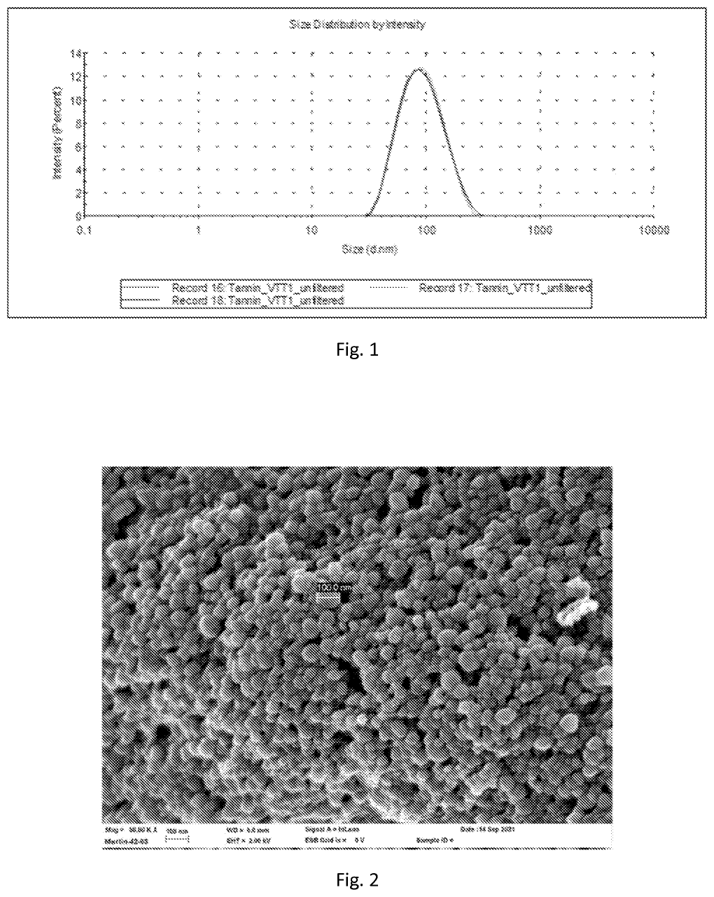

### EMBODIMENTS

### Definitions

In the present context, the term “water-insoluble tannins” comprises tannins that are water-insoluble at ambient temperature and pressure and at their natural (acidic) pH level. Such water-insoluble tannins are obtained from plant-based material, typically from wood-based material and in particular from softwood bark.

Water-soluble tannins, such as those derived from mimosa, quebracho, chestnut, valonea, oak, tara and other typical hardwood sources of extracted tannins cannot form stable nanoparticles on their own as insolubility in water is a prerequisite for nanoparticle formation in water. Therefore, the “TNPs” of the present prior art are not true TNPs but different kinds of tannin-composite nanoparticles.

The present invention is based on the concept of preparing novel TNP dispersions from tannins, which are insoluble in water without pH adjustment at room temperature, by a nanoprecipitation method. The novel TNP dispersions may be used as such or after modification as coatings or surface treatment agents to impart the coated substrates or surfaces with antimicrobial, flame retardant or other functional properties. The method of treating substrates for imparting them with the desired functional properties comprises coating said substrates with the aqueous TNP dispersions of the invention, preferably as a single layer or by depositing alternating layers of aqueous TNP dispersions and of adhesion promoters on the substrates.

Water-insoluble tannins may be obtained from plant-based material, typically from wood-based material, by subjecting the plant-based material to extraction with aqueous alkali or hot water, to obtain an extract consisting mostly of water-insoluble tannins. When the plant-based material is wood-based material, it is preferably softwood material, typically softwood bark. Softwood typically includes but is not limited to spruce, pine or both, more preferably spruce. A preferred plant-based material is spruce bark.

The extraction of plant-based material, such as spruce bark, with aqueous alkali, typically NaOH, or hot water produces an extract comprising tannins that are insoluble in water at room temperature without upward adjustment of pH. Some lignin may be co-extracted with tannin. In one embodiment (VTT1 tannin), water-insoluble tannins comprise water-insoluble tannins extracted from spruce bark using 24% sodium hydroxide at 160° C. (Borrega et a. 2022). In a second embodiment (VTT2 tannin), water-insoluble tannins comprise water-insoluble tannins extracted from spruce bark with hot water at 100° C. In a third embodiment (VTT3 tannin), water-insoluble tannins comprise water-insoluble tannins extracted from spruce bark using 15% sodium hydroxide at 100° C.

The extract, preferably the alkali extract of spruce bark, typically comprises water-insoluble tannins in an amount of at least 50%, preferably at least 60% by weight of the extract. The proportion of other polyphenols, in particular lignin, is typically 0-20%, and carbohydrates, protein and ash make up the balance.

The extract comprising the water-insoluble tannins is mixed with an organic solvent or with a mixture of an organic solvent and water to dissolve the water-insoluble tannins (insolubility in water here means at ambient temperature and pressure without pH adjustment). When the water-insoluble tannins are dissolved in a mixture of an organic solvent and water, the mixture comprises an amount of the organic solvent, which is at least 40% by weight of the combined amount of water and organic solvent. The ratio of organic solvent to water may be optimised according to the solubility characteristics of the tannins.

In embodiments, the organic solvent is selected from acetone, methylethylketone, tetrahydrofuran, ethyl acetate, N,N-dimethylformamide, and alcohols, such as ethanol, isopropanol and ethylene glycol. In one embodiment, the organic solvent is acetone.

In some embodiments, the water-insoluble tannins are dissolved in acetone or in a mixture of acetone and water, wherein the mixture contains an amount of acetone, which is at least 40%, preferably at least 50%, typically 60-80% by weight of the combined amount of water and organic solvent. The proportions of acetone and water may be optimised according to the solubility characteristics of the tannin.

After the dissolution step, any insolubles may be removed, for example by centrifugation. Then, TNPs are prepared by adding the solution comprising the dissolved tannins into an excess of water. Typically, the solution comprising dissolved tannins is poured, preferably rapidly, into an excess of water under stirring. TNPs are formed as the dissolved tannin becomes insoluble in the medium, which is now mostly water. In one embodiment, the solution of dissolved tannins is added to an excess of water under stirring in a volume ratio of the solution of dissolved tannins: water of 1:5-1:10, for example in a volume ratio of about 1:7, to precipitate the tannin as nanoparticles.

The organic solvent is optionally removed from the dispersion, typically by evaporation to obtain an aqueous dispersion comprising TNPs. In one embodiment, where acetone is used as organic solvent, the acetone can be removed by stirring the dispersion in an open vessel or the acetone can be recovered and reused in the process.

The above-disclosed process is called nanoprecipitation or solvent-exchange and results in stable aqueous TNP dispersions.

Typically, the obtained aqueous TNP dispersion, without optional concentration, comprises TNPs in an amount of 0.1 to 5%, or 0.5 to 5%, 0.5 to 2%, preferably 0.5 to 1.5%, or about 1%, based on the weight of the aqueous TNP dispersion. The TNP dispersion may be used for coating as such, without drying or concentration, and without removing the residual acetone or after removing it. However, optionally the dispersion may be concentrated, for example by centrifugation, by partial or full removal of water by lyophilisation, evaporation or by other means known to a person skilled in the art. Depending on the end use, the amount of TNPs in the aqueous dispersion may thus be adjusted higher by concentrating the dispersion. For example, when the aqueous TNP dispersion is used as a flame retardant, the concentration of TNPs in the aqueous dispersion may vary for example from about 1% in an unconcentrated dispersion to about 10% or to about 4-7% in a concentrated dispersion.

In embodiments, the nanoparticles comprise at least 50%, preferably at least 60% tannin by weight of the nanoparticle or consist essentially of tannin.

In the present invention, the TNPs have a size distribution by intensity (Mi), which is below 200 nm, preferably about 100 nm, such as 80-120 nm, or below 100 nm, measured by Dynamic Light Scattering (DLS). Number-based (Mn) hydrodynamic diameters or particle sizes of TNPs are typically smaller than intensity-based particle sizes. Typically, number-based particle size distribution of TNPs is ≤200 nm or ≤100 nm, such as 60-90 nm, measured by Dynamic Light Scattering (DLS).

The form of TNPs is not particularly limited. However, typically TNPs have a spherical form, which is preferred for coating applications.

In embodiments, the TNPs may have a zeta potential value. Typically, the TNPs have a zeta potential value, which is below −30 mV, preferably below −40 mV, meaning that the TNPs have a high negative surface charge. Zeta potential data were obtained from electrophoretic mobility data by applying the Smoluchowski model as disclosed in the experimental section.

The aqueous TNP dispersions may be used as such for different applications.

As disclosed above, in some embodiments the TNPs may be concentrated. In some embodiments, the TNPs may be modified.

Modified TNPs may be obtained for example by subjecting the water-insoluble tannins to nitrogen modification, phosphorous modification, grafting of hydrophobic moieties, and combinations thereof, before the step of dissolving the water-insoluble tannins in an organic solvent or in a mixture of organic solvent and water.

In an embodiment, wherein aqueous TNP dispersions are used as flame retardants, the TNPs preferably comprise nitrogen and/or phosphorus modified tannins, more preferably nitrogen-modified tannins. It has been found that flame retardancy can be enhanced using nitrogen-modified tannin as the starting material of TNPs. In case of fire, non-modified tannin provides a char layer that insulates underlying material. When nitrogen-modified tannin is used, nitrogen-substituents form nitrogen gases that further expand the char layer (intumescence), improving its insulation properties.

Nitrogen-modified tannins are obtained by subjecting the water-insoluble tannins to nitrogen modification. Typically, the nitrogen modification comprises subjecting the water-insoluble tannins to treatment with formaldehyde and urea (Mannich reaction and Schiff base reaction) or other suitable nitrogen-containing chemicals to obtain nitrogen-modified water-insoluble tannins.

In an embodiment, where the tannins have been extracted from spruce bark by alkali extraction, the tannins are dissolved in aqueous alkali solution (or remain in their original alkaline extraction solution) to which nitrogen-containing chemicals, such as urea and aldehydes such as formaldehyde, are added for the nitrogen-modification to take place, preferably under stirring and heating at 50-100° C. for several hours. Finally, the mixture is neutralized with an acid, whereby tannin precipitates, after which the salts are washed off and the product is dried, if so desired.

In some embodiments, the nitrogen modified water-insoluble tannins comprise ≥10% nitrogen, typically 10-13% nitrogen, based on the weight of the modified tannins. The upper limit of nitrogen modification depends on the structure of tannin, i.e., on the number of reactive structures available for nitrogen modification.

An embodiment of the invention relates to a method of treating substrates for imparting them with antimicrobial, flame retardant, barrier or other functional properties, comprising coating said substrates with an aqueous TNP dispersion of the invention.

In one embodiment the method comprises imparting the substrate with barrier properties, wherein the water-insoluble tannins of the TNPs have preferably been subjected to grafting of hydrophobic moieties.

In some embodiments, the method comprises applying on the substrate 1 to 200 g/m², of the aqueous TNP dispersion, depending on the functional properties desired. As apparent to those skilled in the art, application of the aqueous TNP dispersion on the substrate may comprise applying one or several layers of the dispersion on the substrate.

An aqueous dispersion comprising TNPs may be deposited on a substrate surface using any suitable method, such as spraying, dipping, brushing, rod-coating or any other suitable method.

In general, direct adhesion of TNP coating to hydrophilic surfaces (cellulosic and lignocellulosic substrates, viscose) is good, particularly in thin coatings. Some hydrophobic substrates such as plastics may benefit from previous oxidative activation of the surface by plasma or flame treatment to improve coating spreadability and adhesion. In some embodiments, especially when thick flame retardant coatings are prepared from TNPs, particularly from TNPs made with nitrogen-modified tannins, the coatings may show insufficient cohesion (particle-to-particle adhesion) and adhesion to the substrate. Optionally, cohesion and adhesion may be enhanced by including adhesion promoters that do not precipitate the TNPs in the TNP dispersion or, when, e.g., proteins are used as the adhesion promoters, by applying TNPs and proteins as separate layers, particularly if high water resistance of TNP coatings is required. Therefore, in some embodiments, deposited layers of TNPs may be interspersed with deposited layers of protein-based adhesion promoters.

Optional adhesion promoters may include for example vinyl ethylene acetate, acrylates, silicones, polyurethanes and proteins. In one preferred embodiment, the adhesion promoter is selected from plant-based proteins, animal-based proteins and combinations thereof. One example of plant-based proteins suitable for use as an adhesion promoter in the present invention is wheat gliadin.

In one embodiment the method of treating substrates for imparting them with desired functional properties, for example flame retardant properties, may comprise the following steps:
applying a first layer of the aqueous TNP dispersion on the substrate;
applying a layer of adhesion promoter on the first layer of the aqueous TNP dispersion;
applying a second layer of the aqueous TNP dispersion on the adhesion promoter layer; and
   optionally continuing to apply alternating layers of the aqueous TNP dispersion and the adhesion promoter on the substrate, whereby the outermost layer typically comprises a layer of the aqueous TNP dispersion or could also be a layer of adhesion promoter, depending on the type of application.

In one preferred embodiment of the invention, layers of protein are deposited between layers of TNPs to provide coatings that are mechanically very strong and completely or nearly completely water-resistant. The protein permeates the TNP layers and binds to the TNPs via hydrogen bonds and hydrophobic interactions. This further extends the scope of application of TNP coating technology due to the high durability and water resistance of the coatings, without reducing the bio-based content.

Typically, the TNP coating is allowed to dry at ambient conditions. Alternatively, the TNP coating may be cured by thermal crosslinking at an elevated temperature or by UV crosslinking if the optionally selected adhesion promoter requires it. If high temperatures are required for a certain adhesion promoter, the coating must be carried out before the substrate is used in its end-use application.

In some embodiments, the TNP coating may impart antimicrobial properties to the substrate. Antimicrobial properties may be imparted for example by spray application of TNP dispersion to substrates that are already in use in, e.g., hospital environments if the coating can be dried at an ambient temperature. Such coatings may also be replenished easily.

In one embodiment, the method of treating substrates for imparting them with antimicrobial, flame retardant, barrier or other functional properties comprises coating said substrates with an aqueous TNP dispersion comprising 0.1-10%, preferably 0.1-5%, typically 0.5-5%, of TNPs.

Another benefit of the invention is that the coating may be 100% or mostly bio-based, since the main or only ingredient in the TNP dispersions is tannin extracted from plant-based material, preferably from softwood bark, and the preferred adhesion promoter, protein, is also bio-based.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting. Reference throughout this specification to one embodiment or an

embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Unless otherwise stated, properties that have been experimentally measured or determined herein have been measured or determined at room temperature. Unless otherwise indicated, room temperature is 25° C. Unless otherwise stated, properties that have been experimentally measured or determined herein have been measured or determined at atmospheric pressure.

### Experimental

Particle size by Dynamic Light Scattering. A Malvern Zetasizer Nano ZS90 Instrument (UK) was used to measure particle size distributions of TNPs by dynamic light scattering (DLS). The instrument was fitted with a 633 nm He—Ne laser. The measurements were performed at 173° in the backscattering mode. The water viscosity utilized in measurements was 0.89 cP and reflective index 1.33 at 25° C. Approximately 15 to 20 subruns, adjusted automatically by the equipment, were performed for each measurement. From three to five parallel measurements were done per one sample. The TNPs size reported through intensity-based ζ-average hydrodynamic diameter. Additionally, number-based and volume-based hydrodynamic diameters are measured and analysed.

ζ-Potential. A Malvern Zetasizer Nano-ZS90 Instrument (UK) was utilized for the zeta potential determination. Zeta potential data were obtained from electrophoretic mobility data by applying the Smoluchowski model. The measurements were done using a dip cell probe DTS1070 and repeated three-five times for each sample to check the reproducibility. A voltage of ≤5 V was applied.

Micro-scale combustion calorimetry (MCC). Micro-scale combustion calorimetry (MCC), also known as pyrolysis combustion flow calorimetry, is an experimental method for measuring the heat release rate of a small sample as a function of temperature. It reveals how much combustible gases evolve and how much energy is released in the pyrolysis of the specimen tested. The MCC method operates in similar manner thermogravimetric analysis. A small (˜1-5 mg) sample is heated inside a furnace, following a constant heating rate (typically 20-60) K/min). The furnace atmosphere is either inert (N₂) or oxidative (air). The released pyrolysis gases are conducted to the combustion chamber that has a high temperature and a high enough oxygen level to ensure complete combustion.

Peak heat release rate (PHR or PHRR), temperature at PHR (T_{PHR}) and total heat release (THR) were determined by MCC in a nitrogen atmosphere at a heating rate of 1.4 K/s. The char yield was determined gravimetrically. Two replicate tests were performed for each material.

### EXAMPLE 1

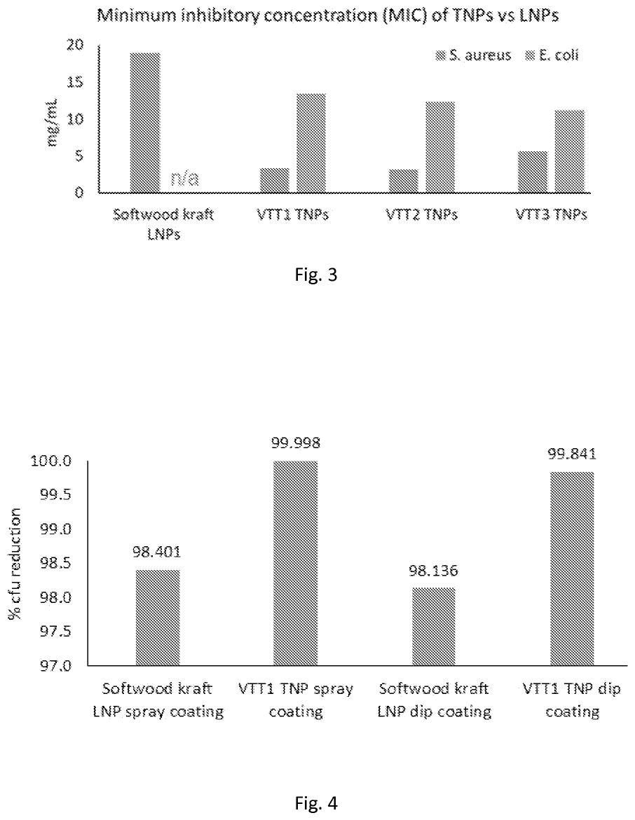

As can be seen in FIG. 3, TNPs effectively inhibit methicillin-resistant Staphylococcus aureus (MRSA) and Escherichia coli (E. coli) compared to lignin nanoparticles (LNPs). The compositions of different tannins used for making TNPs by nanoprecipitation (VTT1, VTT2 and VTT3) are given in Table 1.

TABLE 1
Example compositions of tannins used
for making TNPs by nanoprecipitation

| Extraction | | | | Carbo- | | |
|---|---|---|---|---|---|---|
| method | Code | Tannin | Lignin | hydrates | Ash | Protein |
| Alkali-extraction | VTT1 | 63.1 | 17.2 | 7.3 | 10.2 | 3.1 |
| Hot-water | VTT2 | 57.4 | 14.0 | 5 | 8.1 | 3.2 |
| extraction | | | | | | |
| Mild alkali | VTT3 | 61.5 | 0.2 | 15.7 | 13.1 | 5 |
| extraction | | | | | | |

### EXAMPLE 2

Thin 3 g/m2 TNP coatings and layer-by-layer TNP-gliadin-TNP coatings (3 g/m2 per layer) on cellulose filter paper (Whatman 1) reduce Staphylococcus aureus (S. aureus) bacteria count by 94-99% (bacteriostatic effect). The gliadin layer reduced coating mass loss on water soaking by 75% (from 25% for TNP to 8.3% for TNP-gliadin-TNP). Thicker TNP coatings of 50 g/m2 and 75 g/m2 on 1 mm cellulose sheet reduce the bacteria count by >99.9% (bacteriocidal effect).

TABLE 2
Reduction in the number of colony-forming units (cfu)
of S. aureus E-70045 by thin and thick TNP and
TNP-gliadin-TNP coatings relative to uncoated cellulosic
controls on room temperature incubation for 24 h

| | Cfu/cm² | Reduction, % |
|---|---|---|
| Whatman 1 filter paper samples | | |
| Uncoated control | 654545 | |
| TNP 3 g/m² − sample 1 | 31636 | 95.2 |
| TNP 3 g/m² − sample 2 | 37091 | 94.3 |
| TNP 3 g/m² + gliadin + 3 g/m² + | 25091 | 96.2 |
| TNP 3 g/m² − sample 1 | | |
| TNP 3 g/m² + gliadin + 3 g/m² + | 9818 | 98.5 |
| TNP 3 g/m² − sample 2 | | |
| 1 mm cellulose sheet samples | | |
| Uncoated control | 67636 | |
| TNP 50 g/m² | <40 | >99.94 |
| TNP 75 g/m² | 40 | 99.94 |

### EXAMPLE 3

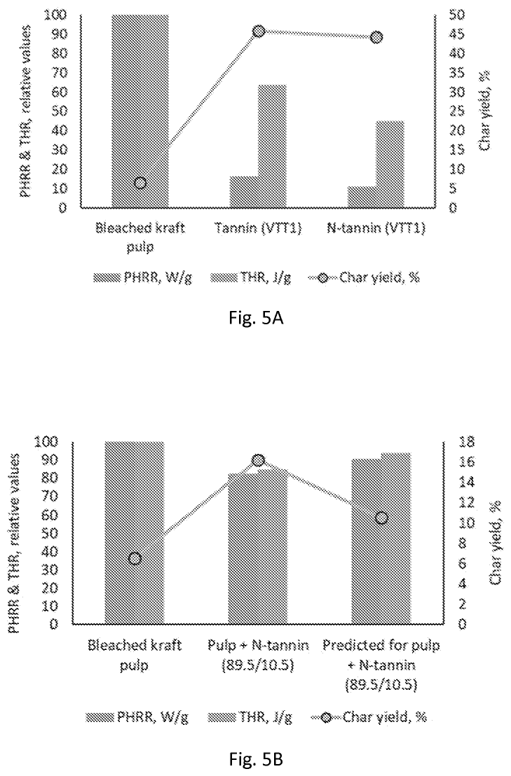

The effect of TNPs made from nitrogen-modified tannin (N-TNPs) as a flame retardant component was tested in micro-scale combustion calorimetry (MCC). The results are summarized in Table 3 and FIG. 5.

TABLE 3
Microcombustion calorimetry (MCC) test results
of uncoated and TNP-coated cellulose. N-TNP = TNPs
made with nitrogen-modified tannin

| | | PHRR | T_{PHRR} | THR | Char yield |
|---|---|---|---|---|---|
| Coating | | (W/g) | (° C.) | (J/g) | (wt-%) |
| Uncoated | Test 1 | 212 | 376 | 10360 | 10.7 |
| cellulose | Test 2 | 203 | 379 | 10030 | 12.3 |
| sheet (Ø | Average | 207 | 378 | 10200 | 11.5 |
| 1.0 mm) | | | | | |
| (ref.) | | | | | |
| TNP, 10 | Test 1 | 194 | 380 | 9690 | 12.2 |
| g/m² | Test 2 | 190 | 380 | 9560 | 13.1 |
| | Average | 192 | 380 | 9630 | 12.7 |
| N- | Test 1 | 140 | 363 | 8250 | 19.0 |
| modified | Test 2 | 143 | 365 | 8320 | 17.8 |
| TNP, 61 | Average | 141 | 364 | 8290 | 18.4 |
| g/m² | | | | | |
| N- | Test 1 | 126 | 362 | 7950 | 19.4 |
| modified | Test 2 | 129 | 362 | 7960 | 19.0 |
| TNP, 89 | Average | 127 | 362 | 7960 | 19.2 |
| g/m² | | | | | |

PHRR = peak heat release rate;
T_{PHRR} = temperature at PHRR
THR = total heat released

A char layer formed on the surface of the burning material is one factor illustrating the flame-retardant performance of the flame-retardant material. The char layer may isolate the substrate surface from oxygen and heat and prevent the volatilisation of degradation products. The FR performance of the char layer depends on the amount and density of the char. A thicker, more porous layer has better FR properties than a thinner, denser layer with the same amount of char. The formation of poorly burning gases, such as ammonia, may also be beneficial to fire behaviour as they can dilute the pyrolysis gases and promote intumescence of the char layer, thereby improving its insulation properties. To summarize, lower PHRR and THR values and a higher char yield are desirable properties for flame retardants.

While the forgoing examples are illustrative of the principles of the present invention in one or more applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in dependant claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in coating industry. TNP coatings are proposed for use for example as easily applicable antimicrobial and flame-retardant surface treatments for building materials, hospital fabrics and privacy curtains, packaging etc.

### ACRONYMS LIST

FR flame retardant
LNP lignin nanoparticle
MIC minimum inhibitory concentration
MSRA methicillin-resistant Staphylococcus aureus
PHR, PHRR peak heat release rate
PVA polyvinyl alcohol
THR total heat release
TNP tannin nanoparticle

### CITATION LIST

### Patent Literature

CN 112472693
CN 113059656
DE 202015100862

### NonPatent Literature

Aguilera et al., Targeted multifunctional tannic acid nanoparticles. RSC Adv. 6, 7279-7287 (2016).
AlMalki et al., Tannin Nanoparticles (NP99) Enhances the anticancer effect of tamoxifen on ER+ breast cancer cells. J. Renewable Materials 9, 2077-2092 (2021).
Borrega et al., Alkaline extraction of polyphenols for valorization of industrial spruce bark. Bioresource Technology Reports 19, 101129 (2022).
Kemppainen et al., Spruce bark as an industrial source of condensed tannins and non-cellulosic sugars. Ind. Crop. Prod. 52, 158-168 (2014).
Limaye et al., Functionalization and patterning of nanocellulose films by surface-bound nanoparticles of hydrolyzable tannins and multivalent metal ions. Nanoscale11, 19278-19284 (2019).
Solis-Pomar et al., A dual active-passive coating with intumescent and fire-retardant properties based on high molecular weight tannins. Coatings 11, 460 (2021).
Widsten, P., et al., Natural Sunscreens Based on Nanoparticles of Modified Kraft Lignin (CatLignin). ACS Omega 5, 13438-13446 (2020).

1. A method of preparing an aqueous tannin nanoparticle dispersion, comprising:
providing tannins that are insoluble in water under ambient conditions without pH adjustment;
dissolving the tannins in an organic solvent or in a mixture of an organic solvent and water to obtain a solution of dissolved tannins;
adding the solution of dissolved tannins into an excess of water to obtain an aqueous dispersion of tannin nanoparticles;
optionally removing residual organic solvent; and
optionally concentrating or drying the dispersion;
wherein the tannin nanoparticles have an intensity-based particle size of ≤200 nm, measured by DLS (Dynamic Light Scattering).

2. The method according to claim 1, wherein the mixture of organic solvent and water comprises an amount of organic solvent, which is at least 40% by weight of the combined amount of water and organic solvent.

3. The method according to claim 1, wherein the organic solvent is selected from acetone, methylethylketone, tetrahydrofuran, ethyl acetate, N,N-dimethylformamide, and alcohols, such as ethanol, isopropanol and ethylene glycol.

4. (canceled)

5. The method according to claim 1, wherein the organic solvent is acetone and the tannins are dissolved in acetone or in a mixture of acetone and water, wherein the mixture contains an amount of acetone, which is at least 40% by weight of the combined amount of water and organic solvent.

6. The method according to claim 1, wherein the adding the solution of dissolved tannins to an excess of water is performed under stirring in a volume ratio of the solution of dissolved tannins: water of 1:5-1:10 to precipitate the dissolved tannins as nanoparticles.

7. The method according to claim 1, wherein the dispersion comprises tannin nanoparticles in an amount of 0.1 to 5% based on the weight of the dispersion, before the optionally concentrating.

8. The method according to claim 1, wherein the providing tannins comprises subjecting plant-based material to extraction with aqueous alkali or hot water, to obtain an extract comprising water-insoluble tannins.

9. The method according to claim 8, wherein the extract comprises at least 50%, water-insoluble tannins by weight of the extract.

10. (canceled)

11. The method according to claim 1, wherein the intensity-based average particle size is 80-120 nm.

12. The method according to claim 1, further comprising a step of
subjecting the tannins to modification selected from nitrogen modification, phosphorous modification, grafting of hydrophobic moieties, and combinations thereof;
before the dissolving the tannins in an organic solvent or in a mixture of organic solvent and water.

13. The method according to claim 12, wherein the method comprises the step of subjecting the tannins to nitrogen modification comprising subjecting the tannins to treatment with formaldehyde and urea to obtain nitrogen-modified water-insoluble tannins.

14. (canceled)

15. The method according to claim 13, wherein the nitrogen modified water-insoluble tannins comprise ≥10% nitrogen based on the mass of the modified water-insoluble tannins.

16. An aqueous tannin nanoparticle dispersion obtained by the method according to claim 1.

17-21. (canceled)

22. A method of treating a substrate for imparting antimicrobial, flame retardant, barrier or other functional properties, comprising coating said substrate with an aqueous tannin nanoparticle (TNP) dispersion obtained by the method according to claim 1.

23. The method according to claim 22, comprising applying on the substrate 1 to 200 g/m² of the aqueous TNP dispersion.

24. (canceled)

25. The method according to claim 22, comprising the steps of
applying a first layer of the aqueous TNP dispersion on the substrate;
applying a layer of adhesion promoter on the first layer of the aqueous TNP dispersion;
applying a second layer of the aqueous TNP dispersion on the adhesion promoter layer; and
optionally applying further alternating layers of the aqueous TNP dispersion and the adhesion promoter on the substrate, whereby the outermost layer comprises a layer of the aqueous TNP dispersion or adhesion promoter.

26. The method according to claim 25, wherein the adhesion promoter comprises at least one of vinyl ethylene acetate, acrylates, silicones, polyurethanes and proteins.

27. The method according to claim 25, wherein the adhesion promoter is selected from plant-based proteins, animal-based proteins and combinations thereof, applied as an aqueous solution of the protein.

28. The method according to claim 25, wherein the adhesion promoter comprises wheat-based gliadin.

29-30. (canceled)

31. The method according to claim 22, wherein the tannins are nitrogen and/or phosphorus modified.

32. The method according to claim 22, wherein the tannins are grafted with hydrophobic moieties.

33. The method according to claim 22, wherein the aqueous TNP dispersion comprises 0.1-10% by weight of TNPs.

34. The method according to claim 22, wherein the substrate is a hydrophobic substrate, which is pre-treated by an oxidative surface activation method before coating the substrate with the aqueous TNP dispersion.

35. (canceled)
